(19) United States
(12) Patent Application Publication
(10) Pub. No.: US 2026/0286748 A1
(43) Pub. Date: Sep. 24, 2026

(54) Control arrangement for the operation of a motor vehicle locking system

(71) Applicant: Brose Schließsysteme GmbH & Co. Kommanditgesellschaft, Wuppertal (DE)

(72) Inventor: Andreas LINSE, Ebensfeld (DE)

(21) Appl. No.: 19/573,848

(22) Filed: Mar. 20, 2026

(30) Foreign Application Priority Data
Mar. 21, 2025 (DE) 102025110960.5

(51) Int. Cl. E05B 81/16; E05B 81/06; E05B 81/80

(52) U.S. Cl. CPC E05B 81/16; E05B 81/06; E05B 81/80

(57) ABSTRACT

A control arrangement for the operation of a motor vehicle locking system, wherein the control arrangement has an energy store with a double-layer capacitor, wherein the double-layer capacitor provides an emergency supply voltage in an emergency operation, in particular in the event of a failure of a normal supply voltage of the motor vehicle, wherein a charging circuit for the double-layer capacitor is provided with a voltage converter, wherein the charging circuit performs the charging in a charging routine with a charging voltage provided via the voltage converter on the basis of the normal supply voltage. It is proposed that the voltage converter is designed to enter a hiccup mode when an overload signal is present at a feedback input, and that the charging circuit in the charging routine connects the feedback input with a control signal to suppress the hiccup mode.

### CROSS-REFERENCE TO RELATED APPLICATION

This application claims priority pursuant to 35 U.S.C. 119(a) to German Patent Application No. 102025110960.5, filed March 21, 2025, which application is incorporated herein by reference in its entirety.

### FIELD OF THE INVENTION

The present invention relates to a control arrangement for the operation of a motor vehicle locking system, to a motor vehicle locking system for a closure element, and to a method for the operation of a motor vehicle locking system.

### BACKGROUND

Motor vehicle locking systems are is used for all types of motorized locking functions for closure elements of a motor vehicle. Closure elements include side doors, rear doors, tailgates, trunk lids, hoods, and the like. These closure elements can generally be designed as swing or sliding doors. The motorized locking function relates to a motor vehicle lock assigned to the motor vehicle locking system.

The known prior art (German Patent Application No. 10 2019 122 109), on which the invention is based, relates to a method for the operation of a motor vehicle locking system having a motor vehicle lock, which has a lock latch and a pawl as locking elements. The lock latch can be brought into a locked position in which it is in holding engagement with the locking part and in which it is fixed by the pawl. The motor vehicle lock is furthermore equipped with an electric drive with which the pawl can be lifted out, so that the lock latch can be adjusted into its open position, releasing the locking part.

To meet the requirements for the safety of the voltage supply of such motor vehicle locks, a rechargeable energy store with a double-layer capacitor can be provided, which ensures the electrical energy supply of the motor vehicle locking system via an emergency supply voltage even in an emergency operation, in particular in the event of a failure of the on-board power supply. A charging circuit is provided for charging the double-layer capacitor, which generates a charging voltage using a normal supply voltage that can be provided via the on-board power supply.

The emergency power supply via the energy store can be used when the central battery is discharged, to maintain access to the vehicle. However, if the vehicle is only operated for a very short time afterwards, the charging of the double-layer capacitor may be insufficient, so that the electrical redundancy is lost again. It is therefore a challenge to charge the double-layer capacitor as quickly as possible, which can be particularly problematic if the double-layer capacitor is already largely discharged.

### SUMMARY

The invention is based on the problem of designing and developing the known control arrangement in such a way that further optimization is achieved with regard to the above challenge.

The invention assumes that the charging circuit is equipped with a voltage converter, wherein the charging circuit charges the double-layer capacitor in a charging routine with a charging voltage provided via the voltage converter using the normal supply voltage.

Commercially available voltage converters are generally not optimized to enable the fastest possible charging of a double-layer capacitor. Rather, the voltage converter is designed to enter a hiccup mode when an overload signal is present at a feedback input. When charging a largely discharged double-layer capacitor, the hiccup mode is triggered in many cases because the charging voltage cannot be built up quickly enough by the voltage converter. Consequently, a delay occurs due to the initial pulsed charging in hiccup mode.

The essential consideration is to still use a pre-made, commercially available voltage converter with such a hiccup mode, but to control the activation of the hiccup mode in a targeted manner.

It is proposed that the charging circuit in the charging routine connect the feedback input with a control signal to suppress the hiccup mode. Instead of a feedback signal intended for the feedback input, which depends on the output voltage or output current of the voltage converter, a control signal is provided to prevent the onset of hiccup mode. Consequently, the double-layer capacitor can be continuously charged with a high charging current, resulting in a significant reduction in charging time.

The invention further relates to a motor vehicle locking system for a closure element of a motor vehicle is claimed. The motor vehicle locking system features an electric drive and a proposed control arrangement for controlling the electric drive. Reference may be made to all the embodiments relating to the proposed control arrangement.

One embodiment of the invention relates to the application of the emergency power supply for a motor vehicle lock, wherein the availability of the energy storage device is of safety relevance.

The invention also relates to a method for the operation of a motor vehicle locking system is claimed. It is essential that the voltage converter is designed to enter a hiccup mode when an overload signal is present at a feedback input, and that the charging circuit in the charging routine connects the feedback input with a control signal to suppress the hiccup mode. Reference may be made to all statements relating to the proposed control arrangement and the proposed motor vehicle locking system.

### BRIEF DESCRIPTION OF THE DRAWINGS

In the following, the invention is explained in more detail with reference to a drawing that merely represents exemplary embodiments. In the drawing:

FIG. 1 shows a motor vehicle door with a motor vehicle locking system comprising a motor vehicle lock and a proposed control arrangement, both in perspective illustrations;

FIG. 2a shows fast charging processes of a double-layer capacitor with a voltage converter with hiccup mode;

FIG. 2b shows fast charging processes of a double-layer capacitor with a voltage converter with suppression of the hiccup mode; and,

FIG. 3 shows a simplified circuit example for the application of a voltage converter with hiccup mode.

### DETAILED DESCRIPTION OF THE INVENTION

The embodiment shown in the drawings which is preferred in this respect relates to a control arrangement 1 for the operation of a motor vehicle locking system 2. The control arrangement 1 controls an electric drive 3 of the motor vehicle locking system 2 to provide a motorized locking function for an adjustable closure element 4 of a motor vehicle 5.

In the present case, the drive 3 can have all types of electric actuators, in particular rotary and linear actuators. Preferably, the control arrangement 1 is configured to control a drive motor 6 of the drive 3, which may be a rotary electric motor, which is further preferably designed as a brushed DC motor or as a brushless DC motor.

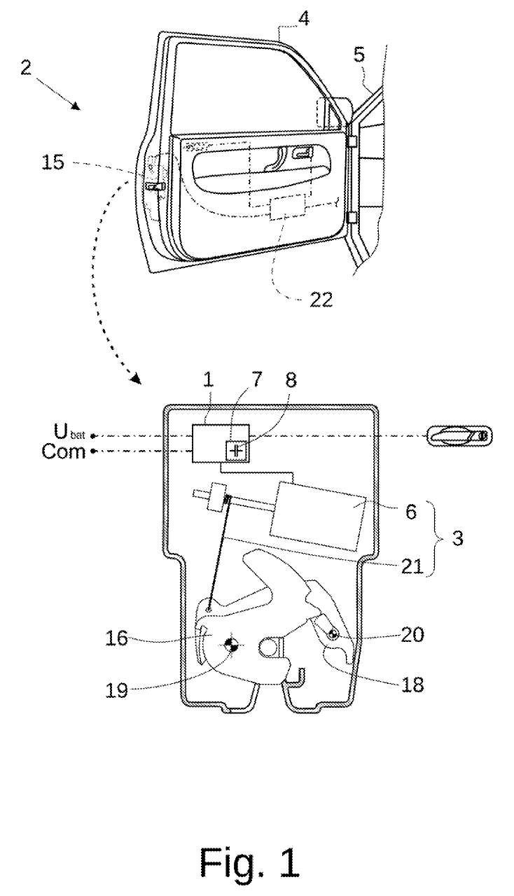

A motorized locking function is understood to mean that the adjustable closure element 4 of the motor vehicle 5 is closed or opened, for example locked or unlocked, directly or indirectly by a movement generated by the electric drive 3, and/or the adjusting element is adjusted, for example opened or closed. As regards the embodiment of the locking element 4, reference may be made to the introductory statements, wherein in this context FIG. 1 shows the mode of operation of the motor vehicle locking system 2 for a locking element 4 designed as a side door. However, all statements also apply to all other types of locking elements of the motor vehicle 5.

The control arrangement 1 and the electric drive 3 are operable in normal operation using a normal supply voltage U_{bat} of the motor vehicle 5. The normal supply voltage U_{bat} used in normal operation is preferably provided by the on-board power supply and in particular by means of the central battery of the motor vehicle 5. The central battery is preferably the battery that provides the electrical energy required for starting the motor vehicle 5 and/or for driving the motor vehicle 5. Normal operation is therefore intended when the normal supply voltage U_{bat} is available for the operation of the drive 3.

The control arrangement 1 has an energy store 7 with a double-layer capacitor 8, wherein the double-layer capacitor 8 provides an emergency supply voltage in an emergency operation, in particular in the event of a failure of the normal supply voltage of the motor vehicle 5. The emergency operation is provided for situations in which the normal supply voltage U_{bat} may not be sufficient to activate the drive 3. Examples of this include failure of the on-board power supply, for example due to a largely discharged central battery or electrical cable failure in the on-board power supply, and in the event of a crash of the motor vehicle 5. If the motorized locking function is triggered in emergency operation, electrical energy can be supplied to the drive 3 using the emergency supply voltage from the energy store 7, here from the double-layer capacitor 8.

In the double-layer capacitor 8, energy storage takes place in an electrochemical double layer, also known as the "Helmholtz layer." Such a double-layer capacitor 8 is also called a “supercapacitor,” “supercap,” “ultracap” or the like. Several double-layer capacitors 8 can be provided, which can basically be connected in series and/or parallel. The energy store 7 may have, in addition to the at least one double-layer capacitor 8, further storage elements, such as primary and/or secondary cells.

A charging circuit 9 for the double-layer capacitor 8 with a voltage converter 10 is provided for charging the energy storage device 7. The voltage converter 10 is provided here, and preferably as a DC-DC converter, which reduces the normal supply voltage to a charging voltage. For example, a normal supply voltage of 12 V or 24 V is provided, wherein the maximum charging voltage, for example for a single double-layer capacitor 8, can be between 2.5 V and 3.0 V.

In a charging routine, the charging circuit9 charges the double-layer capacitor 8 with the charging voltage provided via the voltage converter 10 using the normal supply voltage. The charging routine can be triggered by time control and/or by the occurrence of a charging condition, for example at a certain charge state of the double-layer capacitor 8. In the charging routine, the double-layer capacitor8 is preferably charged to a predetermined state of charge, for example a predetermined target capacitor voltage. The capacitor voltage U_{SC} can be monitored by means of a voltage sensor of the control arrangement 1. Here, and preferably, the double-layer capacitor 8 is charged with the output voltage of the voltage converter 10 via an inductor 11.

The voltage converter 10 is designed to enter a hiccup mode when an overload signal is present at a feedback input 12. The hiccup mode is an operating mode of the voltage converter 10, which serves to protect the voltage converter 10 against a short circuit at the voltage output and/or an output resistance that is too low. In hiccup mode, the voltage converter 10 operates in pulsed mode, wherein an output voltage is built up alternately and repeatedly for a predetermined time and then the operation is interrupted for a predetermined time.

The feedback input 12 is provided for activating or deactivating the hiccup mode; a feedback signal dependent on the output voltage or output current of the voltage converter 10 should be present at this input. If this feedback signal indicates an overload situation, which may be caused by a high output resistance, the voltage converter 10 enters hiccup mode.

Here, the charging circuit 9 in the charging routine is intended to connect the feedback input 12 with a control signal to suppress the hiccup mode. By suppressing the voltage converter 10, it is operated without the hiccup mode even if an overload case of the voltage converter 10 would be present. However, unlike the prior art, no feedback signal is provided at the feedback input 12; instead, a control signal is specifically directed to prevent the hiccup mode from being activated. The control signal is preferably independent of the output voltage and output current of the voltage converter 10.

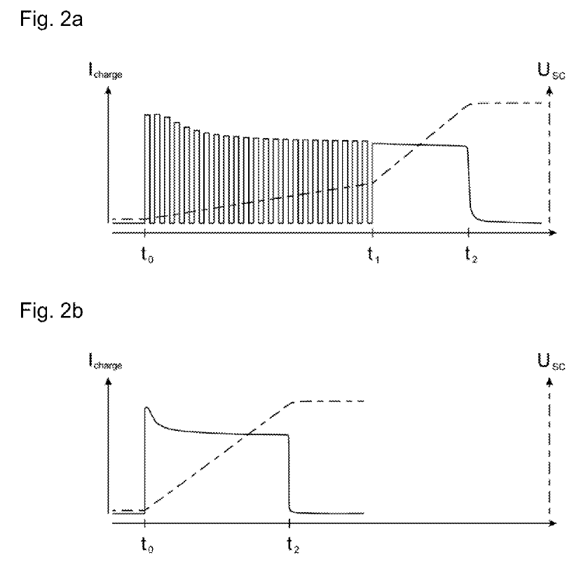

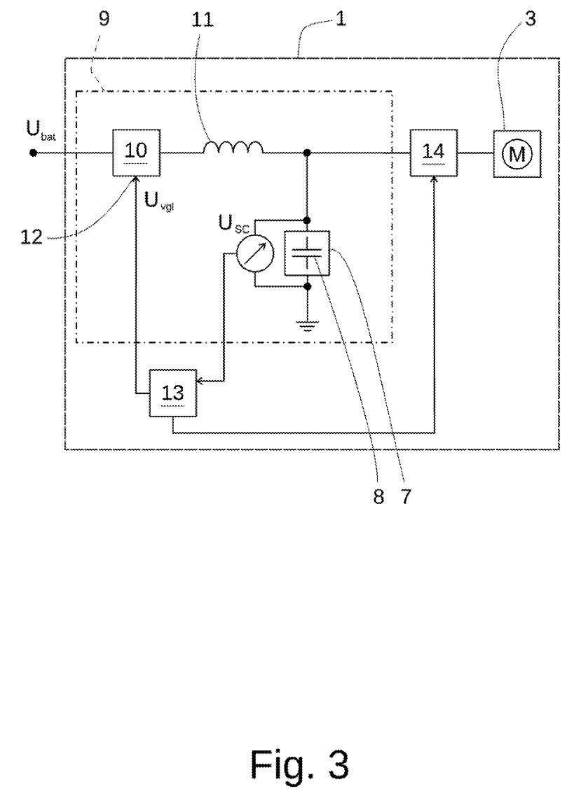

FIG. 2a and FIG. 2b show voltage curves of the charging voltage and charging current during the charging routine over time. FIG. 2a shows a charging routine without suppressing the hiccup mode, with a feedback signal dependent on the output voltage of the voltage converter 10 being present at the feedback input 12. With the double-layer capacitor 8 largely discharged, the voltage converter 10, between the times t₀and t₁, initially was unable to build up a sufficient output voltage, so the voltage converter 10 was operated in pulsed hiccup mode. The hiccup mode is controlled via the pulsed charging current I_{charge} (shown only schematically in FIG. 2a), although in practical application a significantly higher frequency of hiccup pulses may be provided. Only after time t₁ is the double-layer capacitor 8 charged in such a way that a sufficient output voltage can be built up by the voltage converter 10 to operate the voltage converter 10 continuously. This results in a reduced (averaged) charging current in hiccup mode.

FIG. 2b shows the charging routine according to the proposed solution. The control signal at feedback input 12 ensures that the hiccup mode is suppressed even at the beginning of the charging routine, so that the voltage converter 10 can preferably be operated continuously. The resulting total charging time of t₀ to t₂ is accordingly significantly shortened.

Preferably, the voltage converter 10 enters hiccup mode with a voltage at the feedback input 12 that is below a threshold voltage, and the charging circuit 9 uses the feedback input 12 as a control signal in the charging routine with a control voltage U_{vgl}, which is at least the threshold voltage.

The feedback input 12 can, for example, be used to obtain a feedback voltage proportional to the output voltage via a voltage divider. If the feedback voltage falls below the threshold voltage, a short circuit or too low output resistance is assumed and the voltage converter 10 enters hiccup mode. With a control voltage U_{vgl} which is at least the threshold voltage, the hiccup mode can be easily suppressed.

Furthermore, it is preferably provided that the voltage converter 10 has an output current limiter, and that the charging circuit 9 performs the charging routine using the output current of the voltage converter 10 provided via the output current limiter.

The output current limiting is preferably implemented via an internal circuit to the voltage converter 10, which limits the output current to a predetermined maximum current. Here, and preferably, the output current limiting of the voltage converter 10 is used to provide an approximately constant charging current I_{charge}. Overloading of the voltage converter 10 at the beginning of the charging routine, when the hiccup mode could be activated, is avoided by limiting the output current. The double-layer capacitor 8 is thus charged from a largely discharged state with the maximum available output current of the voltage converter 10.

Furthermore, it is preferably provided here that the voltage converter 10 is designed as an integrated electronic module. The voltage converter 10 is thus designed as an integrated circuit, wherein the voltage converter 10 is combined into a single component and is further preferably potted. The integrated electronic module can include the circuitry for implementing the hiccup mode, and particularly the output current limiting.

Furthermore, a control unit 13 is preferably provided here, which controls the charging circuit 9 in the charging routine, and which triggers the switching of the control signal. The control unit 13 is preferably designed as a microcontroller. In addition to the charging routine, the control unit 13 can also perform other control-related tasks, especially for the motorized locking function. Preferably, the control unit 13 operates a driver unit 14 for controlling the electric drive 3. The control unit 13 can be connected to a communication network via a communication interface with a communication network Com of the motor vehicle 5.

In emergency operation, the energy store 7 can be connected to the driver unit 14 for voltage supply. Particularly preferably, the control arrangement 1 has a boost converter assigned to the energy store 7, which is not shown here. The boost converter is designed to increase the energy storage voltage of the energy storage device 7 to an emergency supply voltage for the drive. The energy storage voltage is applied as an input voltage to a voltage input of the boost converter. The boost converter increases the energy storage voltage to a higher emergency supply voltage in comparison.

To trigger the control signal, the control unit 13 can generate the control signal itself, for example via a voltage output of the microcontroller. The control unit 13 can also activate a separate signal generator (not shown here) which generates the control signal using the normal supply voltage.

In a further embodiment, it is provided that the charging circuit 9, in a start phase of the charging routine, connects the feedback input 12 with a control signal to enter hiccup mode. The control signal is selected during the start-up phase in such a way that the hiccup mode is adopted, for example via a control voltage below the threshold voltage. This can be achieved through appropriate programming of the control unit 13 or through a hardware configuration.

The control arrangement 1 can check the charging of the double-layer capacitor 8 during the start-up phase regarding the occurrence of a failure. A failure may be, for example, a short circuit, a defect in the double-layer capacitor 8 or the charging circuit 9. The start-up phase can be kept relatively short and serve only to diagnose the energy storage device 7. The behavior of the charging circuit 9 during the start-up phase determines whether the further charging routine will be carried out.

The charging circuit 9 then connects the feedback input 12 with a control signal to suppress the hiccup mode only if the test shows that the error is absent. If the test reveals an error, the charging routine will not be executed further.

The control arrangement 1 preferably checks the charging of the double-layer capacitor 8 in the start-up phase using the charging voltage of the double-layer capacitor 8. If the charging voltage with the pulses of the hiccup mode, for example, does not reach a specified minimum voltage and/or is above a specified maximum voltage, a failure is assumed.

The test can also be carried out by monitoring the charging current or the charging time during the start-up phase. For testing purposes, the control unit 13 and/or a monitoring unit separate from the control unit 13 may be provided.

According to a further teaching, a motor vehicle locking system 2 for a closure element 4 of a motor vehicle 5 is proposed, the motor vehicle locking system 2 comprising an electric drive 3 and a proposed control arrangement 1 for controlling the electric drive 3.

Preferably, a motor vehicle lock 15 is provided for the closure element 4 of the motor vehicle 5, to which the drive 3 may be assigned. The motor vehicle lock 15 is equipped with a lock latch 16 for holding engagement with a locking part 17 and a locking pawl 18 associated with the lock latch 16. The drive 3 is preferably intended for the motorized lifting of the locking pawl 18.

The motor vehicle lock 15 is shown in FIG. 1 in a partially disassembled side view and is equipped in this case, and preferably, with a lock latch 16 that can pivot about a lock latch axis 19 for holding engagement with a locking part 17 and a pawl 18, which is assigned to the lock latch 16 and can pivot about a pawl axis 20. The locking part 17 can be a locking bat, a locking bolt or the like. For example, the motor vehicle lock 15 is arranged on the closure element 4, while the locking part 17 is fixed to the body of the motor vehicle 5.

Here, the drive 3 is provided as an opening drive for lifting the locking pawl 18. The pawl 18 can be brought into an engaged position as shown in FIG. 1, in which it holds the lock latch 16 in the locked position shown. The drive motor 6 is connected to the pawl 18 via a drive train 21. In FIG. 1, the motorized lifting of the pawl 18 corresponds to the pawl 18 pivoting clockwise about the pawl axis 20. In emergency operation, the function of the drive 3, which is used as an opening drive, is ensured by means of the energy storage device 7. In principle, the pawl 18 can also be part of a pawl system consisting of two or more sequential pawls, which pawl system is assigned to the lock latch 16.

The drive 3 can be provided in an embodiment not shown as a locking drive for locking and unlocking a mechanical actuating chain of an actuating element such as a door handle for the motor vehicle lock 15.

The control arrangement 1 can be integrated into the motor vehicle lock 15, as shown in FIG. 1. Alternatively, it is conceivable that the control arrangement 1 is part of the control unit 22 for the motor vehicle lock 15, which is separate from the motor vehicle lock 15. However, a control unit 22 is not necessarily part of the motor vehicle locking system 2.

In addition to or instead of the locking function of a motor vehicle lock 15 described in detail here, the motor vehicle locking system 2 can also have a drive arrangement for the motorized adjustment of a closure element 4 of the motor vehicle 5 as described above, wherein the drive arrangement serves for the motorized adjustment of the closure element 4, in particular opening and/or closing it. Other examples of locking functions include the motorized adjustment of operating elements along with interior and exterior elements of the motor vehicle 5, such as fan elements, interior mirrors, side mirrors, lighting or the like.

According to a further teaching, a method for the operation of a motor vehicle locking system 2 is proposed, wherein a control arrangement 1 controls an electric drive 3 of the motor vehicle locking system 2 to provide a motorized locking function for an adjustable closure element 4 of a motor vehicle 5, wherein the control arrangement 1 has an energy store 7 with a double-layer capacitor 8, wherein the double-layer capacitor 8 provides an emergency supply voltage in an emergency operation, in particular in the event of a failure of a normal supply voltage of the motor vehicle 5, wherein a charging circuit 9 for the double-layer capacitor 8 with a voltage converter 10 is provided, wherein the charging circuit 9 charges in a charging routine with a charging voltage provided via the voltage converter 10 on the basis of the normal supply voltage.

The essential aspect of this further teaching is that the voltage converter 10 is designed to enter a hiccup mode when an overload signal is present at a feedback input 12, and that the charging circuit 9 in the charging routine connects the feedback input 12 with a control signal to suppress the hiccup mode.

What is claimed is:

1. The control arrangement for the operation of a motor vehicle locking system, wherein the control arrangement activates an electric drive of the motor vehicle locking system in order to provide a motorized locking function for an adjustable closure element of a motor vehicle, wherein the control arrangement comprises an energy store with a double-layer capacitor, wherein the double-layer capacitor provides an emergency supply voltage in an emergency operation, in particular in the event of a failure of a normal supply voltage of the motor vehicle, wherein a charging circuit for the double-layer capacitor is provided with a voltage converter, wherein the charging circuit charges the double-layer capacitor in a charging routine with a charging voltage provided via the voltage converter using the normal supply voltage, wherein the voltage converter is designed to enter a hiccup mode when an overload signal is present at a feedback input, and in that the charging circuit in the charging routine connects the feedback input with a control signal to suppress the hiccup mode.

2. The control arrangement according to claim 1, wherein the voltage converter, with a voltage at the feedback input below a threshold voltage, enters the hiccup mode, and in that the charging circuit in the charging routine connects the feedback input as a control signal with a control voltage which is at least the threshold voltage.

3. The control arrangement according to claim 2, wherein the voltage converter has an output current limiter, and in that the charging circuit performs the charging routine by means of the output current of the voltage converter provided via the output current limiter.

4. The control arrangement according to claim 1, wherein the voltage converter is designed as an integrated electronic module.

5. The control arrangement according to claim 1, wherein a control unit is provided which controls the charging circuit in the charging routine and which triggers the switching of the control signal.

6. The control arrangement according to claim 1, wherein the charging circuit connects the feedback input with a control signal to enter the hiccup mode during a start phase of the charging routine, in that the control arrangement checks the charging of the double-layer capacitor during the start phase with regard to the occurrence of a failure, and in that the charging circuit subsequently connects the feedback input with a control signal to suppress the hiccup mode only if the check shows that there is no failure.

7. The control arrangement according to claim 6, wherein the control arrangement checks the charging of the double-layer capacitor in the start-up phase on the basis of the charging voltage of the double-layer capacitor.

8. The motor vehicle locking system for a closure element of a motor vehicle, the motor vehicle locking system comprising the electric drive and the control arrangement according to claim 1 for controlling the electric drive.

9. The motor vehicle locking system according to claim 6, wherein the motor vehicle lock is provided for the closure element, in that the motor vehicle lock is equipped with a lock latch for holding engagement with a locking part and a pawl assigned to the lock latch, and in that the electric drive is provided for lifting the pawl in a motor-driven manner.

10. A method for the operation of a motor vehicle locking system, wherein the control arrangement activates an electric drive of the motor vehicle locking system in order to provide a motorized locking function for an adjustable closure element of the motor vehicle,
wherein the control arrangement comprises an energy store with a double-layer capacitor, wherein the double-layer capacitor provides an emergency supply voltage in an emergency operation, in particular in the event of a failure of a normal supply voltage of the motor vehicle, wherein a charging circuit for the double-layer capacitor is provided with a voltage converter, wherein the charging circuit charges in a charging routine with a charging voltage provided via the voltage converter on the basis of the normal supply voltage, wherein the voltage converter is designed to enter a hiccup mode when an overload signal is present at a feedback input, and in that the charging circuit in the charging routine connects the feedback input with a control signal to suppress the hiccup mode.

11. The control arrangement according to claim 2, wherein the voltage converter has an output current limiter, and in that the charging circuit performs the charging routine by means of the output current of the voltage converter provided via the output current limiter.

12. The control arrangement according to claim 2, wherein the voltage converter is designed as an integrated electronic module.

13. The control arrangement according to claim 3, wherein the voltage converter is designed as an integrated electronic module.

14. The control arrangement according to claim 2, wherein a control unit is provided which controls the charging circuit in the charging routine and which triggers the switching of the control signal.

15. The control arrangement according to claim 3, wherein a control unit is provided which controls the charging circuit in the charging routine and which triggers the switching of the control signal.

16. The control arrangement according to claim 4, wherein a control unit is provided which controls the charging circuit in the charging routine and which triggers the switching of the control signal.

17. The control arrangement according to claim 2, wherein the charging circuit connects the feedback input with a control signal to enter the hiccup mode during a start phase of the charging routine, in that the control arrangement checks the charging of the double-layer capacitor during the start phase with regard to the occurrence of a failure, and in that the charging circuit subsequently connects the feedback input with a control signal to suppress the hiccup mode only if the check shows that there is no failure.

18. The control arrangement according to claim 3, wherein the charging circuit connects the feedback input with a control signal to enter the hiccup mode during a start phase of the charging routine, in that the control arrangement checks the charging of the double-layer capacitor during the start phase with regard to the occurrence of a failure, and in that the charging circuit subsequently connects the feedback input with a control signal to suppress the hiccup mode only if the check shows that there is no failure.

19. The control arrangement according to claim 4, wherein the charging circuit connects the feedback input with a control signal to enter the hiccup mode during a start phase of the charging routine, in that the control arrangement checks the charging of the double-layer capacitor during the start phase with regard to the occurrence of a failure, and in that the charging circuit subsequently connects the feedback input with a control signal to suppress the hiccup mode only if the check shows that there is no failure.

20. The control arrangement according to claim 5, wherein the charging circuit connects the feedback input with a control signal to enter the hiccup mode during a start phase of the charging routine, in that the control arrangement checks the charging of the double-layer capacitor during the start phase with regard to the occurrence of a failure, and in that the charging circuit subsequently connects the feedback input with a control signal to suppress the hiccup mode only if the check shows that there is no failure.
